(19) United States
(12) Patent Application Publication
(10) Pub. No.: US 2011/0119474 A1
(43) Pub. Date: May 19, 2011

(54) Serial Peripheral Interface BIOS System and Method

(75) Inventors: Anand Singh, Henderson, NV (US); Pravinkumar Patel, Las Vegas, NV (US); Darren LeBlanc, Henderson, NV (US); Robert W. Crowder, JR., Las Vegas, NV (US); James Schaefer, Henderson, NV (US); George Mayfield, Las Vegas, NV (US)

(73) Assignee: BALLY GAMING, INC., Las Vegas, NV (US)

(21) Appl. No.: 12/619,654

(22) Filed: Nov. 16, 2009

(51) Int. Cl. G06F 15/177

(52) U.S. Cl. 713/2

(57) ABSTRACT

Various embodiments disclosed herein are directed to a serial peripheral interface-based (SPI-based) BIOS system for improved upgrading of a BIOS software image in a gaming machine. The system includes a flash BIOS chip and a SPI BIOS chip. The flash BIOS chip is operable to be written to by an Intel chipset for storage of an onboard Ethernet controller's information, wherein the flash BIOS chip may contain a new BIOS software image. The SPI BIOS chip comprises a traditional BIOS including gaming extensions to the BIOS. The SPI BIOS chip can be disabled from write actions at a jumper/circuit level. When a SPI BIOS write enable jumper circuit is ON, a write protect pin of the serial peripheral interface BIOS is in the disabled state. In this regard, when the write protect pin is in the disabled state, the SPI BIOS content may be updated to the new BIOS software image from a BIOS install compact flash. When the BIOS write enable jumper circuit is OFF, the write protect pin of the serial peripheral interface BIOS is in enabled state. In this regard, when the write protect pin is in the enabled state the serial peripheral interface BIOS content cannot be updated

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to a gaming system and, more particularly, to a system and methodology for providing a field upgradeable a BIOS chip that does not require physically replacing the BIOS chip.

### BACKGROUND

The Basic Input Output System (BIOS) provides hardware specific initialization to computers. The BIOS boot firmware is the first code run by a CPU when a computer system is powered on. The functionality provided by a BIOS chip is to detect and initialize the system components as a video card, a network card, serial ports, and a compact flash (CF).

Supporting EPROM based BIOS becomes increasingly challenging due to unavailability of EPROM in bigger sizes (e.g., 8 MByte) to fit in Vendor BIOS (ever increasing in size), the size of the latest kernel (to support the latest chipset), and a more secure ECC based Game Guardian authentication code. The increasing numbers of the CPU manufacturers have been moving away from EPROM based BIOS to SPI BIOS making it to difficult to run the first code from EPROM-based BIOS.

It would be desirable to be able to upgrade a BIOS chip in the field, without physically replacing the BIOS chip.

### SUMMARY

Briefly, and in general terms, various embodiments are directed to a serial peripheral interface-based (SPI-based) BIOS system for improved upgrading of a BIOS software image in a gaming machine. The system includes a flash BIOS chip and a SPI BIOS chip. The flash BIOS chip is operable to be written to by an Intel chipset for storage of an onboard Ethernet controller's information, wherein the flash BIOS chip may contain a new BIOS software image. The SPI BIOS chip comprises a traditional BIOS including gaming extensions to the BIOS. The SPI BIOS chip can be disabled from write actions at a jumper/circuit-level. When a SPI BIOS write enable jumper circuit is ON, a write protect pin of the serial peripheral interface BIOS is in the disabled state. In this regard, when the write protect pin is in the disabled state, the SPI BIOS content may be updated to the new BIOS software image from a BIOS install compact flash. When the BIOS write enable jumper circuit is OFF, the write protect pin of the serial peripheral interface BIOS is in enabled state. In this regard, when the write protect pin is in the enabled state the serial peripheral interface BIOS content cannot be updated.

Another embodiment is directed towards a multiple BIOS method for improved upgrading of a BIOS software image in a gaming machine. The method includes: introducing new BIOS content to a gaming platform on a BIOS update compact flash; booting the gaming machine from a primary BIOS; authenticating the new BIOS content of the BIOS update compact flash using the primary BIOS; flashing the primary BIOS from the new BIOS content; reading the new BIOS content on the primary BIOS using the BIOS update compact flash and verifying the flash was performed correctly; and rebooting the gaming machine for the primary BIOS to boot from newly flashed content.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 illustrates a block diagram of the components of a gaming device.

FIG. 2A illustrates a BIOS content layout of a two chips used in combination mapped into one logical area.

FIG. 2B illustrates a BIOS content layout of a single chips.

FIG. 3 illustrates a BIOS update process.

FIG. 4 illustrates a hard disk partitioning.

FIG. 5 illustrates a boot process.

FIG. 6 illustrates an install package from compact flash to hard disk.

FIG. 7 illustrates one embodiment of a gaming device including the secured module for validating the BIOS.

FIG. 8 illustrates one embodiment of a gaming system network including the gaming devices of FIG. 7.

### DETAILED DESCRIPTION

Various embodiments disclosed herein are directed to gaming devices having a system and method for implementing a Serial Peripheral Interface-based (SPI-based) change that improves the upgrading of a BIOS software image. In this manner, the BIOS performed authentication of the BIOS CF (compact flash), lessens a security risk by assuring that there is no BIOS upgrade until authentication. On the Alpha I/II gaming platform, the BIOS code contains a Linux kernel, certain kernel modules, and Game Guardian® based authentication code. Described herein are BIOS implementation and BIOS type, as well as a method for updating the BIOS firmware in the ALPHA II gaming platform. Changes to the SPI-based BIOS improve the process for upgrading the software image of the BIOS. The BIOS is the root of trust, and currently is on the socket.

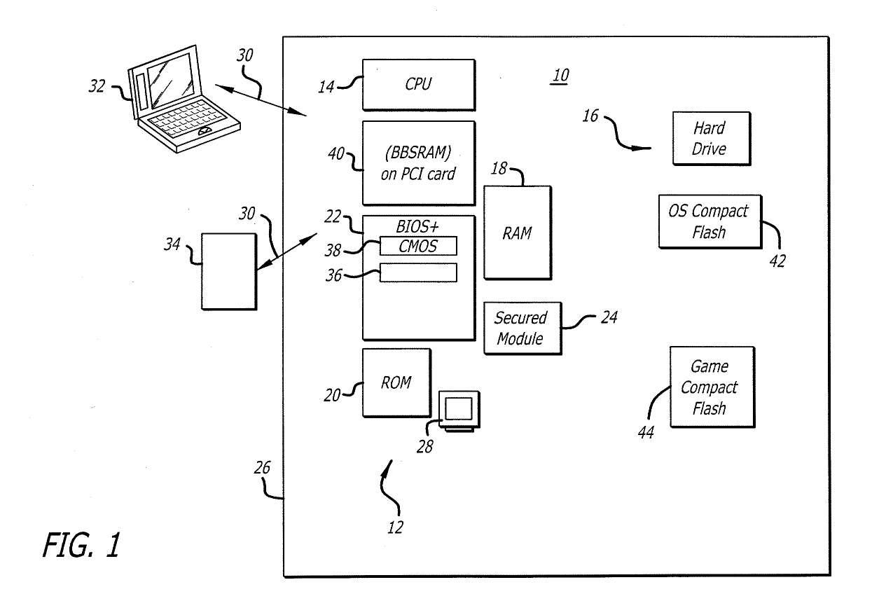

The Alpha II gaming platform employs two Serial Peripheral Interface BIOS chips. The first chip is designed to be written to by the Intel chipset, specifically for the storage of the onboard Ethernet controller's information. The second chip contains the true BIOS including the gaming extensions to the BIOS. In compliance with the NGCB (Nevada Gaming Control Board) regulations, the second BIOS, which contains the control program, must be circuit-level disabled for write actions. Referring now to the drawings, wherein like reference numerals denote like or corresponding parts throughout the drawings and, more particularly to FIGS. 1-3, there are shown various embodiments of a gaming system employing a Serial Peripheral Interface BIOS system.

FIG. 1 illustrates a block diagram of the components 12 of a gaming device 10. The components 12 comprise, for example, and not by way of limitation, software or data file components, firmware components, hardware components, or structural components of the gaming machine 10. These components include, without limitation, one or more processors 14, a hard disk device 16, volatile storage media such as random access memories (RAMs) 18, read-only memories (ROMs) 20 or electrically-erasable programmable ROMs (EEPROMS) such as basic input/output systems (BIOS) 22. Additionally, the gaming device 10 includes a secured module 24. The secured module is a hardware component that is one-time programmable. One or more security algorithms may be provided on the secured module. The security algorithm generates a challenge (e.g., generates a random number), calculates an expected response to the challenge, and determines the validity of the BIOS, based on the response to the challenge provided by the BIOS. In one embodiment, the secured module is a field-programmable gate array (FPGA). In another embodiment, the secured module is a trusted platform module (TPM).

In one embodiment, components 12 also include data files (which are any collections of data, including executable programs in binary or script form, and the information those programs operate upon), gaming machine cabinets (housings) 26, displays 28, or compact disk read-only memory (CDROM) or CD read-write (CR-RW) storage. In one embodiment, the data files may include data storage files, software program files, operating system files, and file allocation tables or structures. Ports 30 are included with the gaming machine 10 for connection to diagnostic systems 32 and other input/output devices 34. In one embodiment, the ports 30 each comprise a serial port, a universal serial bus (USB) port, a parallel port or any other type of known port, including a wireless port. Preferably, each of the components 12 have embedded or loaded in them identification numbers or strings that can be accessed by the processor 14, including the processor 14 itself, which are utilized for authentication as explained below. In one embodiment, the components that are data files each use their file path and name as their identification number or string.

Either within the gaming machine 10, or in the diagnostic system 32 attachable to the gaming machine 10, are executable instructions or a software program 36 for authentication of the components (authentication software 36), which itself may be one of the components 12 to authenticate if it is internal to the gaming machine 10. In one embodiment, authentication software 36 is stored on a persistent storage media such as the hard disk device 16, ROM 20, EEPROM, in a complementary metal oxide semiconductor memory (CMOS) 38, in safe RAM comprising a battery-backed static random access memory (BBSRAM) 40, in flash memory components 42, 44, or other type of persistent memory. In one embodiment, the authentication software 36 is stored in a basic input/output system (BIOS) 22 device or chip. BIOS chips 22 have been used for storing prior authentication software, such as previous versions of the BIOS+ chip used by Bally Gaming Systems, Inc. of Las Vegas, Nev. in their EVO gaming system. Placing the authentication software 36 in the BIOS 22 is advantageous because the code in the BIOS 22 is usually the first code executed upon boot or start-up of the gaming machine 10, making it hard to bypass the authentication process. Alternatively, in one embodiment, the authentication software 36 is stored in a firmware hub (FWH), such as Intel's 82802 FWH.

As an alternative, instead of, or in conjunction with, the hard disk device, another mass storage device is used, such as a CD-ROM, a CD-RW device, a WORM device, a floppy disk device, a removable type of hard disk device, a ZIP disk device, a JAZZ disk device, a DVD device, a removable flash memory device, or a hard card type of hard disk device.

It should be noted that the term, gaming device, is intended to encompass any type of gaming machine, including hand-held devices used as gaming machines such as cellular-based devices (e.g., phones), PDAs, or the like. The gaming device can be represented by any network node that can implement a game and is not limited to cabinet-based machines. The system has equal applicability to gaming machines implemented as part of video gaming consoles or handheld or other portable devices. In one embodiment, a geo-location device in the handheld or portable gaming device may be used to locate a specific player for regulatory and other purposes. Geo-location techniques that can be used include by way of example, and not by way of limitation, an IP address lookup, a GPS, a cell phone tower location, a cell ID, a known Wireless Access Point location, a Wi-Fi connection used, a phone number, a physical wire or port on the client device, or by an accessed middle tier or backend server. In one embodiment, GPS and biometric devices are built within a player's client device, which in one embodiment comprises a player's own personal computing device, or is provided by the casino as an add-on device using USB, Bluetooth, IRDA, serial or another interface to the hardware to enable jurisdictionally compliant gaming, ensuring the location of play and the identity of the player. In another embodiment, the casino provides an entire personal computing device with these devices built in, such as a tablet-type computing device, PDA, a cell phone or another type of computing device capable of playing system games.

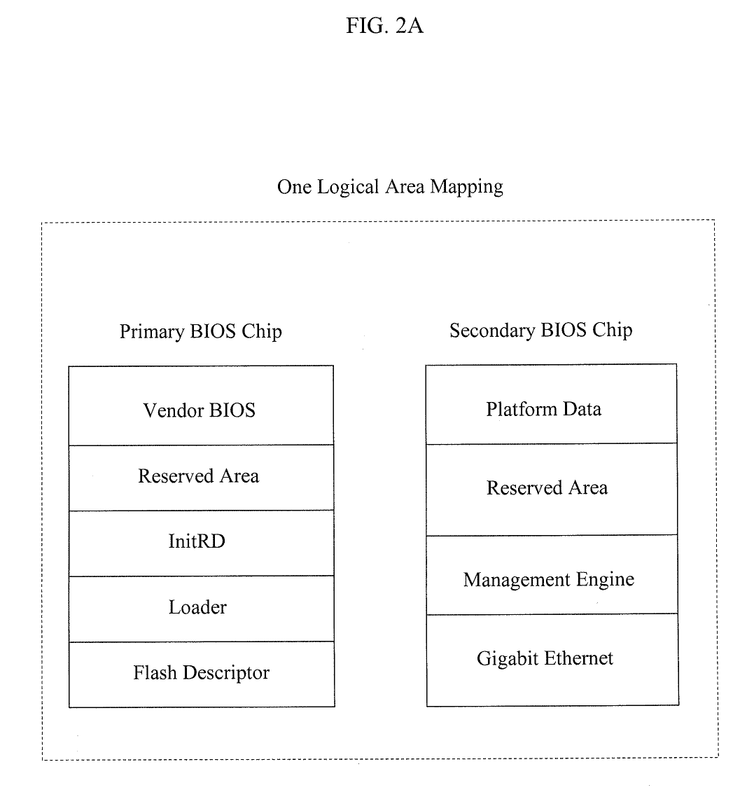

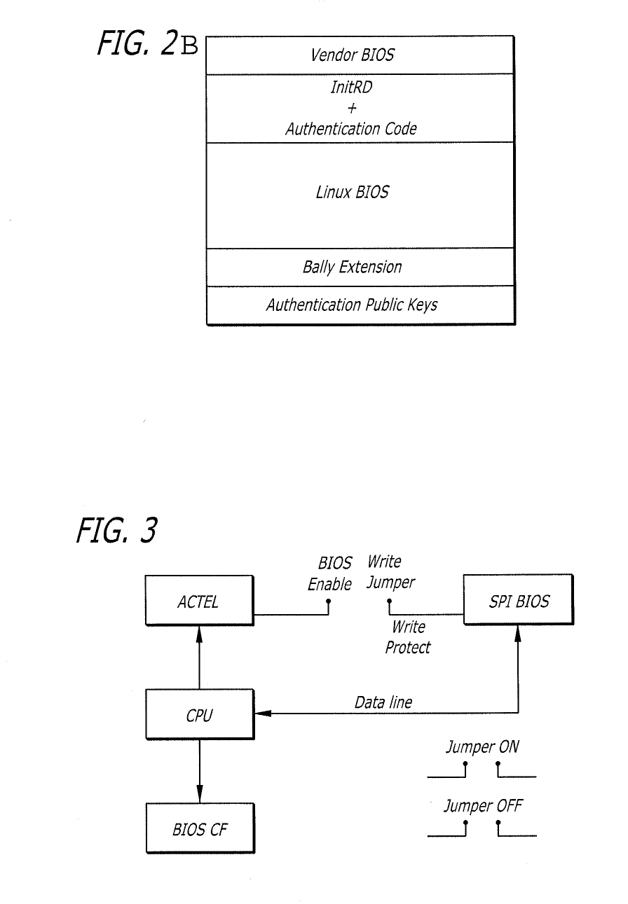

One embodiment of a Serial Peripheral Interface BIOS system is described herein with respect to FIGS. 2A, 2B, 3. ALPHA II gaming platform supports a Serial Peripheral Interface flash based BIOS to overcome all challenges listed. In one embodiment the Serial Peripheral Interface flash on the Alpha II board is used in a descriptor mode. In descriptor mode, the flash is divided into five regions:

| Regions | Content |
|---|---|
| 0 | Flash Descriptor |
| 1 | BIOS |
| 2 | Management Engine |
| 3 | Gigabit Ethernet |
| 4 | Platform Data |

In this regard, only three masters can access the four regions:

1. A Host processor running BIOS code
2. An integrated Gigabit Ethernet
3. A Host process running Gigabit Ethernet Software, and Management Engine.

Preferably, each master is only allowed to perform direct reads of its primary regions. In one embodiment, the ALPHA II gaming platform is not utilizing the Management Engine feature. In this regard, the information in the Flash Descriptor may be written during the manufacturing process as its read/write permissions are set to “read only” after first write. In one such embodiment, the management engine, gigabit Ethernet, and platform data reside on a separate SPI chip other than the BIOS SPI chip.

With respect to the Serial Peripheral Interface BIOS in the Alpha II board, in one specific non-limiting embodiment, the Alpha II SPI Chip is 8 MByte in size and is on the socket. FIG. 2A shows the BIOS content layout of a two chips used in combination. Notably, there are two physical BIOS chips that are mapped into one logical area. The primary BIOS chip includes the following contents: Vendor BIOS, Reserved Area, InitRD, Loader, and Flash Descriptor. The secondary BIOS chip includes the following contents: Platform Data, Reserved Area, Management Engine, and Gigabit Ethernet.

The BIOS content layout of a single chip is illustrated in FIG. 2B. The BIOS contents are: (1) Firmware boot code (Vendor BIOS), (2) InitRD+Authentication Code, (3) Linux Kernel, (4) Manufacturer Extension, and (5) Public keys. The Firmware boot code detects and initializes the system components such as a video card, a network card, serial ports, a compact flash, and the like. The Initial Ram Disk (InitRD) is a temporary file system used in a Linux kernel boot process. Authentication code is an ECC-based Game Guardian® authentication algorithm used to authenticate manifest as well as legacy game media on either Hard Disk or CF. The Linux Kernel performs standard Kernel functions. The Manufacturer Extension is responsible for self-validating the BIOS content, loading the Linux kernel, and InitRD. Lastly, the Public keys are used in the authentication process.

Referring now to FIG. 3, the BIOS update process is illustrated. Regulators or other authorized person may update the contents of BIOS by using manufacturer authentic software to update the Serial Peripheral Interface BIOS content. When the BIOS Write Enable Jumper is “ON” the write protect pin of the Serial Peripheral Interface BIOS is in the disabled state. In this configuration, the Serial Peripheral Interface BIOS content can be updated. When the BIOS Write Enable Jumper is “OFF” the write protect pin of the Serial Peripheral Interface BIOS is in enabled state. In this configuration, the Serial Peripheral Interface BIOS content cannot be updated. The Gaming Platform software detects the jumper status and prevents a game from loading in the case BIOS where the Write Enable jumper is ON. To update the BIOS, the BIOS Write Enable jumper must be ON.

The following describes the BIOS update method as shown in FIG. 3. On power up/reset, the Serial Peripheral Interface BIOS self-validates, and if successful, moves to authenticate the manifest files on hard disk and/or compact flash media. The mechanism allows only manufacturer-specific, digitally-signed software to update the BIOS image.

The new BIOS content is introduced to the ALPHA II gaming platform on a Compact Flash. Once gaming machine is booted from the manufacturer-specific BIOS, the BIOS then authenticates the BIOS update compact flash. In this manner, an option is presented of upgrading the content of BIOS with the latest firmware (both part numbers are displayed to an operator authorized to perform this operation). The operator may then select to perfoiin the update operation by key-switching the operator key.

In one embodiment, the BIOS update software then starts flashing the BIOS. Once finished, the update software reads the BIOS content back and verifies that the flash was performed correctly. The status is displayed to an operator. The operator is required to reboot the MPU board for the BIOS to boot from the newly-flashed content. Interrupting the BIOS update process causes the BIOS chip to have to be replaced.

In one embodiment, the Serial Peripheral Interface BIOS improves overall system security over that of currently existing environments. With this new setup provided by the Serial Peripheral Interface BIOS system, once a gaming machine is programmed from the manufacturer, no other party can compromise it, as no such rogue software can be run on the system. Additionally, the need for a bigger-sized BIOS need is eliminated, which combined with the bigger BIOS, is harder and more expensive to obtain. Additionally, the Serial Peripheral Interface BIOS provides ease in upgrading the new BIOS image, given that no special burner is needed.

The following is a description of an enhanced Main Processing Unit (MPU) which serves as the principle control electronics for gaming machine components including the Serial Peripheral Interface BIOS. The Alpha II MPU enhances the Alpha control system by employing advanced technologies. Such technological components include: an Intel® GS45 chipset-based Core 2 Duo processor; up to 4G Byte Dual Channel DDR3 system RAM; 32 M Byte (16 MB per Bank) battery-backed, non-volatile RAM (expandable up to 64 MB); Serial ATA (SATA) based Solid State Hard Disk Drive for program storage; SPI based Flash BIOS; a PCIe x16 v2.3 expansion slot for Video Graphics card; a PCIe x1 expansion slot; Two ports with Gigabit Ethernet; Intel High Definition Audio; new backplane to support additional serial port, S/PDIF digital audio output, two (2) USB 2.0 ports and five (5) spare digital I/O; and two compact flash slots to perform installation and programming of Hard Disk Drive and BIOS, and clearing of non-volatile RAM.

The following sections of the document describe the use, contents and methods of programming: Solid State HDD (hard disk drive), Flash BIOS, and ACTEL Field Programmable Gate Array (FPGA).

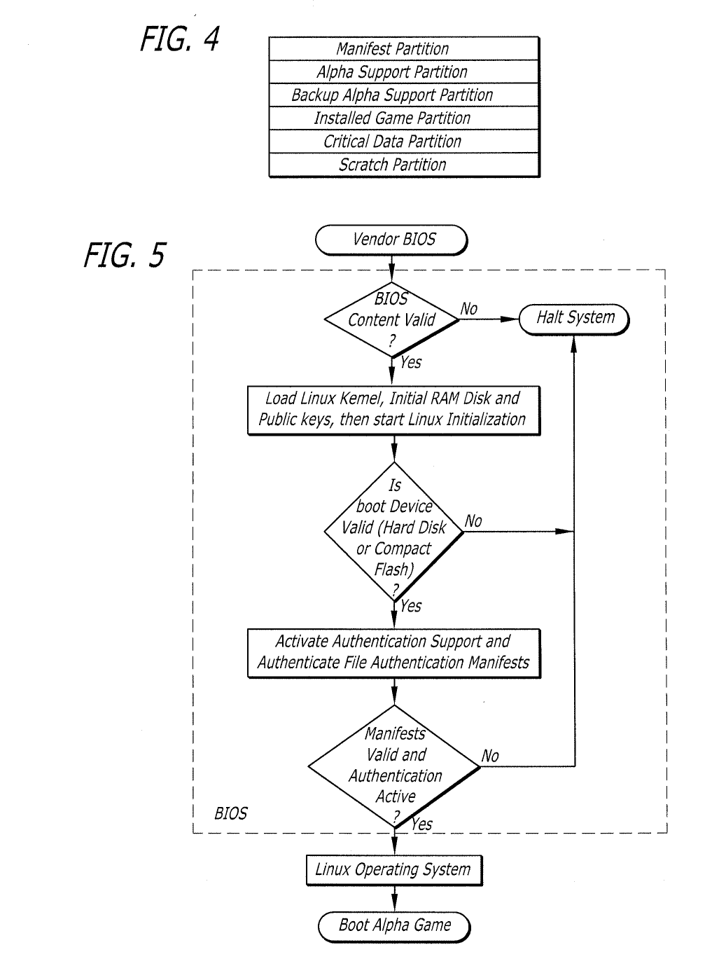

Referring now to the Solid State HDD, a brief description of the partitions that exist on the hard disk is present with reference to FIG. 4. These partitions include the manifest partition, the alpha support partition, the installed game partition, the critical data partition, and the scratch partition. In some embodiments, additional partitions may be added as requirements dictate. In this regard, the manifest partition contains file authentication manifest files used to authenticate the contents of files stored on the hard disk.

In one embodiment, the alpha support partition contains all of the files needed to run the Alpha Support operating system and provides the support code required to run games on the gaming machine. Preferably, two alpha support partitions are created on the hard disk. One is used as the primary partition which is mounted as the Linux Root partition when the system is booted. The other partition is used to install new Alpha support on the gaming machine. When new Alpha Support is saved in the backup partition, the backup partition becomes the primary partition and the previous primary partition becomes the backup partition. If the newly-installed Alpha Support fails to boot properly, a reboot defaults to using the previous Alpha Support partition that now resides in the backup partition. Once the newly-installed Alpha support has booted successfully, any subsequent boot failure causes the system to halt with an error.

Referring now to the installed game partition, the installed game partition contains an image file for the game to be run. The game can be one of the following: (1) a PVSSR Manifest based Game; (2) a DSS/DSA Manifest based Game; or (3) a DSS/DSA File Signature Table (FST) based game. After the game image has been mounted, the image appears the same as a compact flash.

In another aspect of one embodiment, the critical data partition is used to store critical data such as install logs, history tracking information, status and other critical data. No programs can be run from this partition. Executing clear on the platform deletes all the information stored in the critical partition.

In still another aspect of one embodiment, the scratch partition is used to store temporary files. These files include download packages, temporary message and video files, and the like. Any download packages stored in this partition are authenticated before being installed on another partition. No executable files are allowed to execute from this partition. Executing clear on the platform deletes all the information stored in the scratch partition.

Referring now to the formatting of the hard disk, a special compact flash called the Install Flash is booted on the gaming machine and used to partition and format the hard disk and to install installation packages. The entire hard disk is zeroed out during the format process. The installation packages reside on a Media compact flash.

With respect to data security, new technology introduced in the ALPHA II gaming machine no longer supports inhibiting writes to the Serial ATA based storage media via a hardware patch. The Serial ATA (SATA) support on the new Alpha platform differs from a traditional Parallel ATA interface. In SATA, the only method of communication is over two serial differential pairs. A transmit pair and a receive pair are used to send serial commands to the drive and also to read data from the drive. Protecting a SATA drive potentially requires logic to intercept certain hardware commands and enable other commands to pass through complex custom logic. This would introduce timing and signal integrity issues which would jeopardize data integrity as speeds have reached the 3 Gbit/second range. These methods would also be subject to becoming non-functional as SATA drive command sets are revised.

Write Protection on a Parallel ATA-based Hard Disk Drive was possible, because it is accessed using a discrete write strobe which may be inhibited as needed. With the advancement of technology, PATA interfaces have become obsolete and are being replaced by faster, higher-performance serial interfaces. The modern Intel Chipsets used today no longer support the PATA interface. As a result, a number of software measures are being taken to insure the security of the data on the hard disk. These different security measures create a number of levels of security to insure the integrity and authenticity of the data.

Referring now to software security measures, preferably, the authentication code and the public key used to perform the authentication of data are stored in the gaming machine's BIOS. The authentication support is initialized and activated during the BIOS boot process. The Alpha Support, Games and Jurisdiction data software parts are digitally signed. These signatures are authenticated before any code is executed from the above-mentioned parts. In one embodiment, the DSS/DSA (both manifest as well as File Signature Table) signed games have a digital security strength of 1024 bits. The Game Guardian® signed software parts have a digital security strength of 256 bits (equivalent to 3072 bits DSS/DSA algorithm).

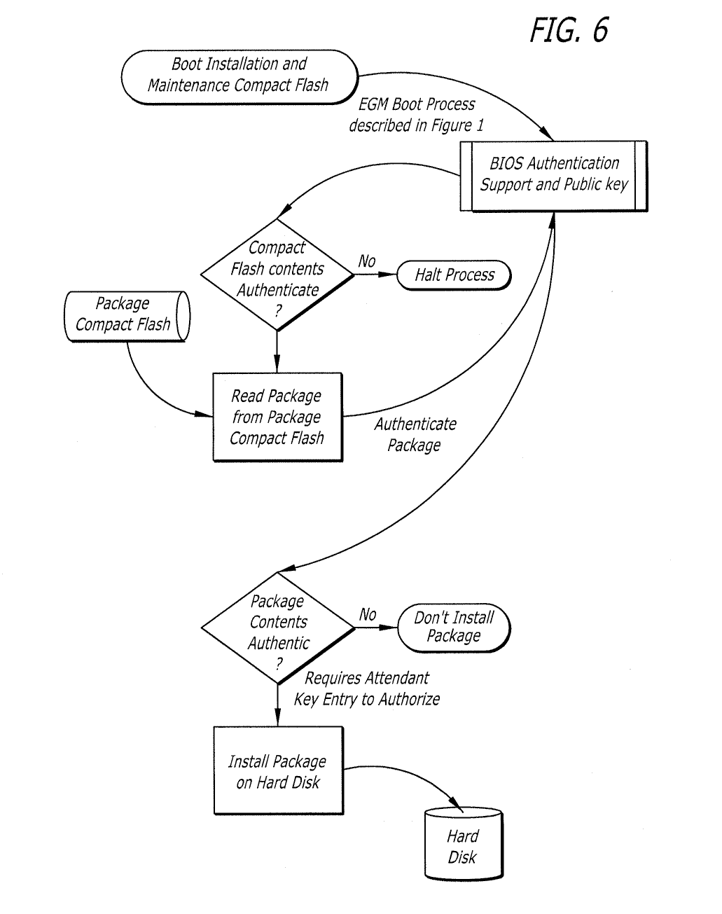

Referring now to the boot process, as shown in FIG. 5, on power up/reset, the Vendor BIOS executes and initializes the hardware and peripheral and then, calls a manufacturer's BIOS extension code. In one embodiment, the manufacturer's BIOS extension code validates the entire BIOS space using a SHA-1 (the BIOS space is a sub-set of BIOS chip). If unsuccessful, the system fault is raised and no further booting of the system is allowed.

In an aspect of one embodiment, the Linux Kernel, Authentication, Memory Validation and Fault Manager Modules are loaded from BIOS into the system RAM. The Authentication module then reads and authenticates the contents of a Jurisdiction chip and the contents of all the manifest files stored on the ALPHA Support compact flash. Based on the type of the Game compact flash, if the Game flash contains manifest files, the files are authenticated. Otherwise, the contents of the entire game flash are authenticated using a DSS signature. If authentication in any of the above steps fail, the system fault is raised and no further booting of the system is allowed.

Once the authentication is completed, control is passed back to the Linux kernel to initialize the system operating environment and start the game. In addition to boot-time authentication, several other measures are taken during run-time. In this regard, as each read-only file covered by a File Authentication Manifest file is opened, the entire contents of the file is authenticated. If the contents of the file cannot be authenticated, a system fault is raised and no additional processing is allowed on the machine until the problem has been resolved.

In another aspect of one embodiment, a background kernel task that is part of the authentication code continuously authenticates the contents of the File Authentication Manifest files and all the files defined within them. If any of the files fail to authenticate, or if a file is missing, a system fault is raised, and the system is halted. Furthermore, in addition to the files being defined as read-only, the partitions in which the files are stored are also mounted as read-only. In one preferred embodiment, no code is allowed to execute from the Manifest, Critical Data and Scratch partitions. All of the above measures insure that only manufacturer-signed software is allowed to run on the system.

Referring now to information storage on the hard disk, any game or Alpha support that is to be stored on the hard disk is contained within an installation package. The installation package is either retrieved from a Package Compact Flash or from a Download Server. In this regard, packages are authenticated before they are installed on the hard disk.

In still another aspect of one embodiment, the clear flash program zeros out the NVRAM data storage and backplane EEPROM. The clear flash program then reads back to verify that all zeros were successfully written. In addition to NVRAM and backplane EEPROM, the clear flash program removes all files in the Critical Data Partition and Scratch Partition of the hard drive.

Referring now to installation from the media compact flash, to install a package from the package compact flash, the gaming machine is booted using the Install Flash. The Install Flash is a special compact flash that does not support running a game on the gaming machine. In this regard, the Install Flash only supports formatting the hard disk and installing packages onto the hard disk.

The installation package from the compact flash to the hard disk is shown in FIG. 6. As illustrated in FIG. 6, the gaming machine is booted from the Install Flash. In this regard, control is given to the Package Install program which reads the package from the media compact flash. The media compact flash has one or more packages in download package format. First, the package is authenticated. Then if the package is authentic, the package is installed on the hard disk. If, however, the package does not pass authentication, an error is raised and no data is copied to the hard disk.

In one embodiment, the current and future released games that reside on a compact flash are treated as type of Install Flash that may be copied to the hard disk. In the case of current game compact flashes, the image of the complete game compact flash is copied onto the hard disk after the game compact flash has been authenticated. The signature of the legacy games is not changed regardless of the media (hard disk or compact flash) from which it is loaded and/or executed.

In one embodiment, the A3P1000FG484 Field Programmable Gate Array (FPGA), which is part of Actel's ProASIC3 family, is used on the ALPHA II printed circuit board. This family has the core FLASH (configuration FLASH) embedded into the component and is programmed via a JTAG port. ACTEL ProASIC3 on ALPHA II supports the following functionalities. First, the general I/O includes discrete In and Out registers, a general-purpose timer and player switches. Second, in one embodiment, the serial communication devices include twelve (12) 16550 equivalent UARTs to support peripherals (e.g., the Bill Validator, the Printer, and the like) and the SAS Host communication. Third, with respect to Non-volatile RAM (NVRAM), in one embodiment, up to 64 MBytes of non-volatile RAM (32 MB per bank) is supported on the platform. NVRAM access is 32-bit and read always returns full 32-bit DWORD, regardless of which bytes are enabled. Write actions can be any combination of BYTE, WORD or DWORD. To write to NVRAM, the NVRAM write enable register must be enabled. Finally, with respect to coin mechanisms and hopper FIFO (first in first out), in one embodiment, the FIFO is 15-bits wide by 63 WORDs deep, and is used to sample various status inputs that change too fast for standard polling techniques. This enables the states of the inputs to be monitored at regular time intervals, without interrupting the processor on every update. The sample rate is controlled by the Real-Time Latency Register (RTLR).

In another aspect of a preferred embodiment, the Alpha II hardware platform enables programming of FPGA via available JTAG connectors. There are several levels of security in this architecture as follows. With respect to the elimination of external configuration memories, since the configuration FLASH is embedded into the FPGA component and is programmed at the factory, there are no external program bit-streams available for monitoring. This prevents a third party from reading or writing the configuration code, via an external serial bitstream.

Additionally, the Alpha II hardware platform enables no read access to internal configuration. In this regard, the FLASH Configuration FLASH code is “write only.” Verification may only be performed by downloading the identical file to the FPGA and comparing the file (internally) to the existing configuration FLASH contents. Since the configuration FLASH isn't readable, the code is not available for upload and analysis. In this regard, trial and error would be impractical since the program code is several million bits long.

Referring now to message authentication control (MAC), to prevent internal damage to the FPGA from invalid configuration files, an authentication process (Actel proprietary) is in place. The MAC verifies that the code is valid before loading the code into the configuration FLASH. This procedure helps prevent erroneous code from being downloaded and reduces the risk of tampering. Moreover, with respect to verification, the internal contents of the configuration FLASH may be verified via the JTAG port, without compromising the code. Since the verification process occurs internally to the FPGA, the contents are never uploaded and remain secure.

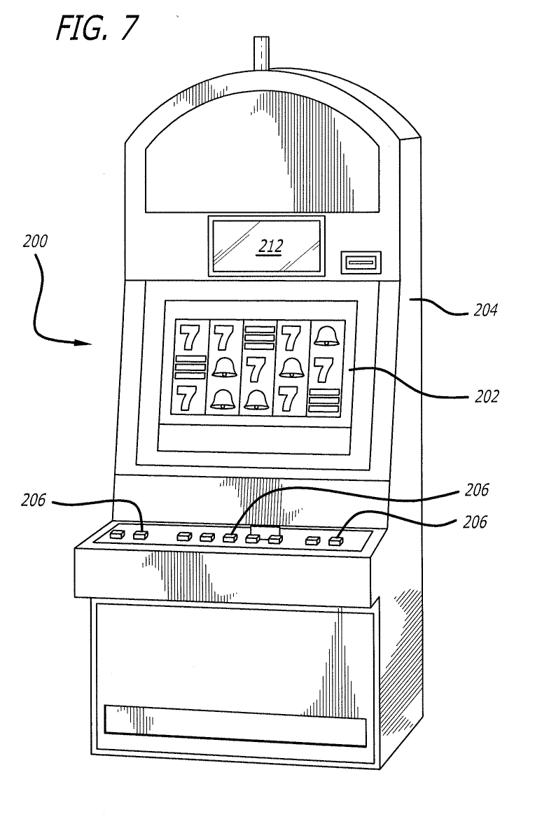

FIG. 7 illustrates one embodiment of a gaming device including the secured module for validating the BIOS. Turning to FIG. 7, the main cabinet 204 of the gaming machine 200 is a self-standing unit that is generally rectangular in shape. In another embodiment, the main cabinet 204 may be a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine 200 may instead be a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 7, the gaming machine 200 includes a main display 202. According to one embodiment, the main display 202 is a plurality of mechanical reels for presenting a slot-style game. Alternatively, the main display 202 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 202 is a widescreen display (e.g., 16:9 or 16:10 aspect ratio display). In one embodiment, the display 202 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 202 may be mounted in the gaming cabinet 204 in a portrait or landscape orientation. In another embodiment, the game display 202 may also include a touch screen or touch glass system (not shown). The touch screen system allows a player to input choices without using any electromechanical buttons 206. Alternatively, the touch screen system may be a supplement to the electromechanical buttons 206.

The main cabinet 204 of the gaming machine also houses a game management unit (not shown) that includes a CPU, circuitry, and software for receiving signals from the player-activated buttons 206 and a handle (not shown), operating the games, and transmitting signals to the respective game display 206 and speakers (not shown). Additionally, the gaming machine includes an operating system such as Bally Gaming's Alpha 05, as disclosed in U.S. Pat. No. 7,278,068, which is hereby incorporated by reference.

In various embodiments, the game program may be stored in a memory (not shown) comprising a read-only memory (ROM), volatile or non-volatile random access memory (RAM), a hard drive or flash memory device or any of several alternative types of single or multiple memory devices or structures.

As shown in FIG. 7, the gaming machine 200 includes a plurality of player-activated buttons 206. These buttons 206 may be used for various functions such as, but not limited to, selecting a wager denomination, selecting a number of games to be played, selecting the wager amount per game, initiating a game, or cashing out money from the gaming machine 200. The buttons 206 function as input mechanisms and may include mechanical buttons, electromechanical buttons or touch screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, a touch pad, a track ball, a mouse, switches, and toggle switches, are included with the gaming machine to also accept player input. Optionally, a handle (not shown) may be “pulled” by a player to initiate a slots-based game.

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

In some embodiments, the gaming machine 200 is part of a gaming system connected to or with other gaming machines as well as other components such as, but not limited to, a Systems Management Server (SMS) and a loyalty club system (e.g., casino management personnel/system (CMP/CMS)). Typically, the CMS/CMP system performs casino player tracking and collects regular casino floor and player activity data. The gaming system may communicate and/or transfer data between or from the gaming machines 200 and other components (e.g., servers, databases, verification/authentication systems, and/or third party systems).

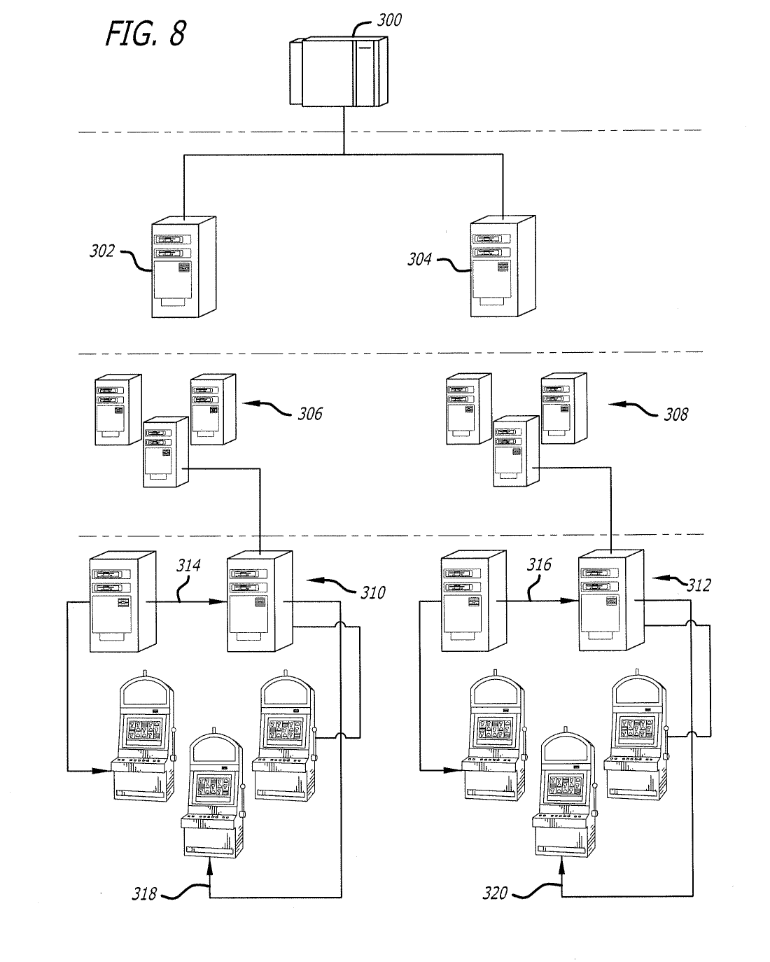

An embodiment of a network that may be used with the system is illustrated in FIG. 8. The example network consists of a top-level vender distribution point 300 that contains all packages for all jurisdictions; one or more Jurisdiction distribution points 302 and 304 that contain regulator approved production signed packages used within that jurisdiction or sub-jurisdiction; one or more Software Management Points 306 and 308 to schedule and control the downloading of packages to the gaming machine; and a one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 101 or 104 or from the gaming servers 103.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A serial peripheral interface-based BIOS system for improved upgrading of a BIOS software image in a gaming machine, the system comprising:
a flash BIOS chip, wherein the flash BIOS chip is operable to be written to by an Intel chipset for storage of an onboard Ethernet controller's information, wherein the flash BIOS chip may contain a new BIOS software image; and
a SPI BIOS chip, wherein the SPI BIOS chip comprises a traditional BIOS including gaming extensions to the BIOS, wherein the SPI BIOS chip is operable to be disabled from write actions at a jumper/circuit level;
wherein when a SPI BIOS write enable jumper circuit is ON, a write protect pin of the serial peripheral interface BIOS is in the disabled state, wherein when the write protect pin is in the disabled state, the SPI BIOS content may be updated to the new BIOS software image from a BIOS install compact flash;
wherein when the BIOS write enable jumper circuit is OFF, the write protect pin of the serial peripheral interface BIOS is in enabled state, wherein when the write protect pin is in the enabled state the serial peripheral interface BIOS content cannot be updated.

2. The system of claim 1, wherein the BIOS performed authentication of the BIOS compact flash, lessens a security risk by assuring that there is no BIOS upgrade until authentication.

3. The system of claim 1, wherein flash memory of the Serial Peripheral Interface is used in a descriptor mode.

4. The system of claim 3, wherein the flash memory is divided into five regions including flash descriptor, BIOS, management engine, gigabit Ethernet, and platform data.

5. The system of claim 4, wherein masters that may access the regions include a host processor running BIOS code, an integrated Gigabit Ethernet, and host process running Gigabit Ethernet Software.

6. The system of claim 5, wherein each master is only allowed to perform direct reads of its primary regions.

7. The system of claim 4, wherein the information in the flash descriptor may be written during manufacturing since read/write permissions of the flash descriptor are set to read only after a first write.

8. The system of claim 4, wherein the management engine, gigabit Ethernet, and platform data reside on a separate SPI chip from the BIOS SPI chip.

9. A multiple BIOS method for improved upgrading of a BIOS software image in a gaming machine, the method comprising.
introducing new BIOS content to a gaming platform on a BIOS update compact flash;
booting the gaming machine from a primary BIOS;
authenticating the new BIOS content of the BIOS update compact flash using the primary BIOS;
flashing the primary BIOS from the new BIOS content;
reading the new BIOS content on the primary BIOS using the BIOS update compact flash and verifying the flash was performed correctly; and
rebooting the gaming machine for the primary BIOS to boot from newly flashed content.

10. The method of claim 1, further comprising: presenting an option of upgrading to the new BIOS content, wherein each option is displayed to an operator authorized to perform this operation, after the step of authenticating the new BIOS content of the BIOS update compact flash using the primary BIOS.

11. The method of claim 1, further comprising: selecting to perform an update operation by key-switching an operator key, after the step of presenting an option of upgrading to the new BIOS content.

12. The method of claim 1, further comprising: displaying a status to an operator, after the step of reading the new BIOS content on the primary BIOS using the BIOS update compact flash and verifying the flash was performed correctly.

13. A multiple BIOS system for improved upgrading of a BIOS software image in a gaming machine, the system comprising:
a field programmable gate array;
serial peripheral interface BIOS containing a first partition, wherein the serial peripheral interface BIOS may be connected to the field programmable gate array via a BIOS write enabling jumper circuit, wherein the first partition is initially designated as a primary partition and is mounted as a Linux root partition when the system is initial booted;
a central processing unit, wherein the central processing unit is connected to the field programmable gate array, and wherein the central processing unit in connected to the serial peripheral interface BIOS; and
a BIOS flash containing a second partition, wherein the BIOS flash is connected to the central processing unit, wherein the second partition is initially designated as a backup partition to install new gaming support on the gaming machine, wherein when new gaming support is saved in the second partition, the second partition becomes designated as a primary partition and the first partition becomes designated as a backup partition.

14. The system of claim 13, wherein, if new gaming support fails to boot properly, a reboot default causes previous gaming support to be used that resides in the backup partition.
